(19) United States
(12) Patent Application Publication
(10) Pub. No.: US 2026/0061408 A1
(43) Pub. Date: Mar. 5, 2026

(54) CATALYST COMPOSITION FOR OLEFIN OLIGOMERIZATION

(71) Applicant: INDUSTRIAL TECHNOLOGY RESEARCH INSTITUTE, Hsinchu (TW)

(72) Inventors: Yin-Hsiang SU, Tainan City (TW); Kuo-Chen SHIH, New Taipei City (TW); Hao-Hsun YANG, Tainan City (TW); Feng-Ming HSIEH, Tainan City (TW)

(73) Assignee: INDUSTRIAL TECHNOLOGY RESEARCH INSTITUTE, Hsinchu (TW)

(21) Appl. No.: 19/030,866

(22) Filed: Jan. 17, 2025

(30) Foreign Application Priority Data
Aug. 28, 2024 (TW) 113132370

(51) Int. Cl. B01J 31/18; B01J 31/12

(52) U.S. Cl. CPC B01J 31/189; B01J 31/122; B01J 2231/20; B01J 2531/0213; B01J 2531/31; B01J 2531/62

(57) ABSTRACT

A catalyst composition process for olefin oligomerization is provided. The catalyst composition includes a chromium compound, wherein the chromium compound has at least one substituted or unsubstituted phosphate ligand, a ligating compound, and a cocatalyst. The catalyst composition for olefin oligomerization of the disclosure includes a specific chromium compound (such as a chromium-containing phosphate compound).

### CROSS REFERENCE TO RELATED APPLICATIONS

This application claims priority of Taiwan Patent Application No. 113132370, filed on Aug. 28, 2024, the entirety of which is incorporated by reference herein.

### TECHNICAL FIELD

The disclosure relates to a catalyst composition for olefin oligomerization.

### BACKGROUND

In recent years, continuous innovations in polymer synthetic materials have driven a growing demand for high-performance synthetic materials. High-grade linear alpha-olefins such as 1-hexene, 1-octene, and 1-decene are increasingly used in applications such as high-performance polyolefin materials, synthetic lubricant base oils, oil additives, and detergents, with a steadily rising demand. Selective ethylene oligomerization is the primary method for producing high-purity linear alpha-olefins like 1-hexene, 1-octene, and 1-decene. In particular, selective ethylene trimerization for producing 1-hexene and ethylene tetramerization for producing 1-octene have become key research areas in both academia and industry in recent years.

The technology for producing linear alpha-olefins from ethylene through oligomerization includes both non-selective and selective ethylene oligomerization. Non-selective ethylene oligomerization has certain drawbacks, including high-byproduct (1-butene) content and low selectivity for high-grade linear alpha-olefins (such as 1-hexene, 1-octene, and 1-decene). In contrast, selective ethylene trimerization and tetramerization can generate high-grade linear alpha-olefins like 1-hexene and 1-octene with high selectivity. This method also offers advantages such as high product value, mild reaction conditions, and simple process routes. As a result, it has become a key focus of research and technological development in this field in recent years.

However, conventional catalyst compositions for ethylene trimerization and tetramerization still suffer from issues such as high-byproduct content and suboptimal polymerization activity. Therefore, improving selectivity for target products and increasing oligomerization reaction activity are key to the development of olefin oligomerization catalyst compositions.

### SUMMARY

According to embodiments of the disclosure, the disclosure provides a catalyst composition for olefin oligomerization, includes a chromium compound, a ligating compound and a cocatalyst, wherein the chromium compound has at least one substituted or non-substituted phosphate ligand.

A detailed description is given in the following embodiments.

### DETAILED DESCRIPTION

The catalyst composition of the disclosure is described in detail in the following description. In the following detailed description, for purposes of explanation, numerous specific details and embodiments are set forth in order to provide a thorough understanding of the present disclosure. The specific elements and configurations described in the following detailed description are set forth in order to clearly describe the present disclosure. It will be apparent, however, that the exemplary embodiments set forth herein are used merely for the purpose of illustration, and the inventive concept may be embodied in various forms without being limited to those exemplary embodiments. In addition, the drawings of different embodiments may use like and/or corresponding numerals to denote like and/or corresponding elements in order to clearly describe the present disclosure. However, the use of like and/or corresponding numerals in the drawings of different embodiments does not suggest any correlation between different embodiments. As used herein, the term “about” in quantitative terms refers to plus or minus an amount that is general and reasonable to persons skilled in the art.

Furthermore,, the use of ordinal terms such as “first”, “second”, “third”, etc., in the disclosure to modify an element does not by itself connote any priority, precedence, or der of one claim element over another or the temporal order in which it is formed, but are used merely as labels to distinguish one claim element having a certain name from another element having the same name (but for use of the ordinal term) to distinguish the claim elements.

It should be noted that the elements or devices in the drawings of the disclosure may be present in any form or configuration known to those skilled in the art. In addition, the expression “a layer overlying another layer”, “a layer is disposed above another layer”, “a layer is disposed on another layer”, and “a layer is disposed over another layer” may refer to a layer that directly contacts the other layer, and they may also refer to a layer that does not directly contact the other layer, there being one or more intermediate layers disposed between the layer and the other layer.

The disclosure provides a catalyst composition for olefin oligomerization. The catalyst composition for olefin oligomerization of the disclosure includes a specific chromium compound (such as a chromium-containing phosphate compound). The chromium compound of the disclosure may serve as a catalyst precursor in the ethylene trimerization/tetramerization reaction for use in concert with a ligating compound, a cocatalyst, and/or an additive, thereby forming a catalytically active system with higher catalyst activity and improved product selectivity.

The disclosure provides a catalyst composition for olefin oligomerization. According to embodiments of the disclosure, the catalyst composition for olefin oligomerization includes a chromium compound, a ligating compound, and a cocatalyst, wherein the chromium compound has at least one substituted or non-substituted phosphate ligand.

According to embodiments of the disclosure, the molar ratio of the chromium compound to the ligating compound may be 1:1 to 1:5, such as 1:1.1, 1:1.2, 1:1.3, 1:1.5, 1:2, 1:2.5, 1:3, or 1:4.

According to embodiments of the disclosure, the molar ratio of the chromium compound to the cocatalyst may be 1:5 to 1:30, such as 1:6, 1:7, 1:8, 1:10, 1:12, 1:15, 1:20, or 1:25.

According to embodiments of the disclosure, the chromium compound of the disclosure may have a structure represented by Formula (I)

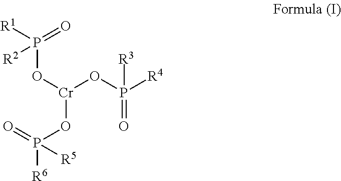

wherein R¹, R², R³, R⁴, R⁵ and R⁶ are independently hydrogen, C1-C25 alkyl group, or C1-C25 alkoxy group, and at least one of R¹, R², R³, R⁴, R⁵ and R⁶ is C1-C25 alkyl group, or C1-C25 alkoxy group.

According to embodiments of the disclosure, in the chromium compound of Formula (I), R¹, R², R³, R⁴, R⁵ and R⁶ are independently C1-C25 alkyl group, or C1-C25 alkoxy group. According to embodiments of the disclosure, C1-C25 alkyl group may be linear or branched alkyl group.

According to embodiments of the disclosure, C1-C25 alkyl group may be methyl, ethyl, propyl, butyl, pentyl, hexyl, heptyl, octyl, nonyl, decyl, undecyl, dodecyl, tridecyl, tetradecyl, pentadecyl, hexadecyl, heptadecyl, octadecyl, nonadecyl, eicosyl, heneicosyl, docosyl, tricosyl, tetracosyl, pentacosyl, or an isomer thereof.

According to embodiments of the disclosure, C1-C25 alkoxy group may be a linear or branched alkoxy group. According to embodiments of the disclosure, C1-C25 alkoxy group may be methoxy, ethoxy, propoxy, butyloxy, pentyloxy, hexyloxy, heptyloxy, octyloxy, nonyloxy, decyloxy, undecyloxy, dodecyloxy, tridecyloxy, tetradecyloxy, pentadecyloxy, hexadecyloxy, heptadecyloxy, octadecyloxy, nonadecyloxy, eicosyloxy, heneicosyloxy, docosyloxy, tricosyloxy, tetracosyloxy, pentacosyloxy, or an isomer thereof.

According to embodiments of the disclosure, at least one of R¹, R², R³, R⁴, R⁵ and R⁶ is a group having a structure represented by Formula (II) or Formula (III)

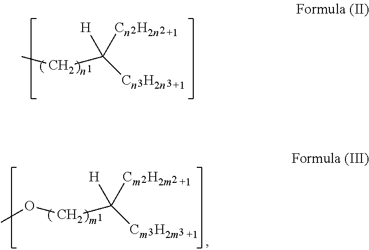

wherein n¹, n², and n³ are independently 0 or an integer of 1-8 (such as 1, 2, 3, 4, 5, 6, 7, or 8); and m¹, m², and m³ are independently 0 or an integer of 1-8 (such as 1, 2, 3, 4, 5, 6, 7, or 8).

For example, the group of Formula (II) may be

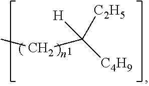

wherein n¹ may be an integer of 1-8, such as 1, 2, 3, 4, 5, 6, 7, or 8; the group of Formula (III) may be

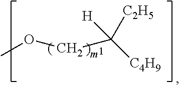

wherein m¹ may be an integer of 1-8, such as 1, 2, 3, 4, 5, 6, 7, or 8.

According to embodiments of the disclosure, in the chromium compound of the disclosure, R¹, R³ and R⁵ may be the same, and R², R⁴ and R⁶ may be the same. According to some embodiments of the disclosure, R¹, R², R³, R⁴, R⁵ and Rothe same, and R¹, R², R³, R⁴, R⁵ and R⁶ may be C1-C25 alkyl group, or C1-C25 alkoxy group.

According to embodiments of the disclosure, the ligating compound may have a structure represented by Formula (IV) or Formula (V)

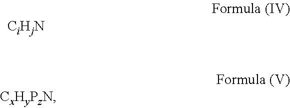

wherein i is an integer of 5-20, j is an integer of 7-37, x is an integer of 7-38, y is an integer of 19-49, and z is an integer from 2-4.

According to embodiments of the disclosure, the ligating compound may be a pyrrole compound having a structure represented by Formula (VI)

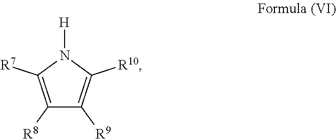

wherein R⁷, R⁸, R⁹ and R¹⁰ are independently hydrogen, or C1-C4 alkyl group, and at least one of R⁷, R⁸, R⁹ and R¹⁰ is C1-C4 alkyl group.

According to embodiments of the disclosure, the ligating compound may be 2,5-dimethylpyrrole, 2-methyl-5-ethylpyrrole, 2,5-diethylpyrrole, 2,5-dipropylpyrrole, 2,5-dibutylpyrrole, 2,4-dimethylpyrrole, 2,4-diethylpyrrole, 2,4-dipropylpyrrole, 2,4-dibutylpyrrole, 3,4-dimethylpyrrole, 3,4-diethylpyrrole, 3,4-dipropylpyrrole, 3,4-dibutylpyrrole, 2,3,4-trimethylpyrrole, 3-ethyl-2,4-dimethylpyrrole, 2,3,5-trimethylpyrrole, 2,3,4,5-tetramethylpyrrole, 2,3,4,5-tetraethylpyrrole, or a combination thereof.

According to embodiments of the disclosure, the ligating compound of the disclosure may be a compound having a structure represented by Formula (VII)

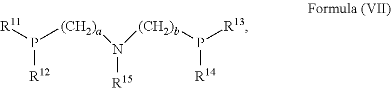

wherein R¹¹, R¹², R¹³ and R¹⁴ are independently C1-C6 alkyl group, C4-8 cycloalkyl group, C6-C12 aryl group, or C7-C22 alkylaryl; R¹⁵ is C1-C6 alkyl group, or C4-8 cycloalkyl group; a is 0, or an integer of 1-6; and b is 0, or an integer of 1-6.

According to embodiments of the disclosure, the ligating compound may be bis(diphenylphosphino)methylamine, bis(diphenylphosphino)ethylamine, bis(diphenylphosphino)isopropylamine, bis(diphenylphosphino)isobutylamine, or a combination thereof.

According to embodiments of the disclosure, the cocatalyst is aluminoxane, alkylaluminum, or a combination thereof.

According to embodiments of the disclosure, the cocatalyst is linear or cyclic methylaluminoxane, ethylaluminoxane, n-propyl aluminoxane, iso-propyl aluminoxane, or a combination thereof.

According to embodiments of the disclosure, the cocatalyst has a structure represented by Formula (VIII)

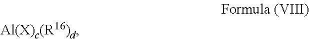

wherein X is fluorine, chlorine, bromine, or iodine; R¹⁶ is C1-C6 alkyl group; c is 0, 1, or 2; d is 1, 2, or 3; and c+d is 3.

According to embodiments of the disclosure, the catalyst composition for olefin oligomerization further comprises a reaction accelerator.

According to embodiments of the disclosure, the molar ratio of the chromium compound to the reaction accelerator may be 1:1 to 1:10, such as 1:2, 1:3, 1:4, 1:5, 1:6, 1:7, 1:8, or 1:9.

According to embodiments of the disclosure, the reaction accelerator is fluorine-substituted C2-C4 alkane, chlorine-substituted C2-C4 alkane, bromine-substituted C2-C4 alkane, or a combination thereof.

According to embodiments of the disclosure, the reaction accelerator is trichloroethane, tetrachloroethane, pentachloroethane, hexachloroethane, trifluoroethane, tetrafluoroethane, pentafluoroethane, hexafluoroethane, or a combination thereof.

The disclosure also provides an olefin oligomerization process, which includes mixing a catalyst composition and a solvent to obtain a catalyst system; and subjecting an olefin to an oligomerization reaction in the presence of the catalyst system, wherein the catalyst composition is the catalyst composition disclosed above.

According to embodiments of the disclosure, the solvent may be propane, butane, pentane, hexane, cyclopentane, cyclohexane, methylcyclopentane, methylcyclohexane, toluene, xylene, mesitylene, ethylbenzene, or a combination thereof.

According to embodiments of the disclosure, in the catalyst system, the concentration of chromium is from 1×10⁻⁶ mol/L to 0.1 mol/L, such as 1×10⁻⁵ mol/L, 1×104 mol/L, 1×10⁻³ mol/L, or 1×10⁻² mol/L.

According to embodiments of the disclosure, the catalyst composition and process of the disclosure are used for the oligomerization of ethylene.

According to embodiments of the disclosure, the catalyst composition and process of the disclosure are used for the trimerization of ethylene, with a main product of 1-hexene.

According to embodiments of the disclosure, the catalyst composition and process of the disclosure are used for the tetramerization of ethylene, with a main product of 1-octene.

The catalyst system of the disclosure catalyzes the trimerization/tetramerization of ethylene and can utilize a “solvent-free” reaction system. In a solvent-free system, the reaction product may act as the solvent or diluent in the reactor. For example, when ethylene is trimerized to form 1-hexene, 1-hexene can act as the solvent or diluent in the reactor. The reaction temperature and pressure can be any values that create conditions suitable for the trimerization of olefin. When the reactant is primarily ethylene, a temperature range of approximately 0° to about 300° C. is typically used. The reaction pressure is usually within the range of about atmospheric pressure to about 2500 psi. Furthermore, hydrogen may be added optionally to enhance product selectivity, thereby reducing the formation of byproducts.

According to embodiments of the disclosure, the evaluation of product selectivity can be performed using gas chromatography (GC) to analyze the obtained products, and reaction activity can be calculated by weighing.

Below, exemplary embodiments will be described in detail with reference to the accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### Example 1

A high-pressure reaction kettle (300 mL) was heated at 120° C. under vacuum for at least 4 hours to remove moisture and oxygen from the reactor. Next, under nitrogen atmosphere, cyclohexane (CH) (5 mL), triethyl aluminum (TEA) (94.5 μmol), 1,1,2,2-tetrachloroethane (TCE) (31.5 μmol), 2,5-dimethylpyrrole (DMP) (18.9 μmol), and chromium compound (I) (having a structure of

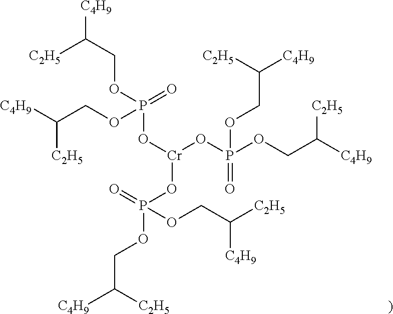

(6.3 μmol) (hereinafter referred to as Cr(P204)₃) were sequentially added into a reaction bottle. After stirring for 30 minutes, a solution (A) was obtained.

Next, under nitrogen atmosphere, cyclohexane (CH) (5 mL) and triethyl aluminum (TEA) (94.5 μmol) were added into a reaction bottle. After stirring for 30 minutes, a solution (B) was obtained.

After injecting solution (A) into a feed tube, the feed tube was installed into the high-pressure reaction kettle and an ethylene feed tube was also installed into the high-pressure reaction kettle. Next, air was removed from the connection points. After cooling the high-pressure reaction kettle to room temperature, cyclohexane (90 mL) was added into the high-pressure reaction kettle and stirred at a rotation speed of over 500 rpm. After replacing the nitrogen in the reactor with ethylene, the solution (B) was injected into the high-pressure reaction kettle and then the high-pressure reaction kettle was heated to 80° C. Next, the solution (A) was injected from the feed tube into the high-pressure reaction kettle using ethylene at 550 psi. After 30 minutes of reaction, the high-pressure reaction kettle was cooled to 20° C. using an ice bath and then the pressure was released. The product was analyzed by gas chromatography. The results show a 97% selectivity for 1-hexene, less than 1% selectivity for polyethylene (PE), and a catalyst activity of 7.8×10⁵ g/g-Cr h⁻¹.

### Example 2

Example 2 was performed in the same manner as in Example 1, except that Chromium compound (I) (having a structure of

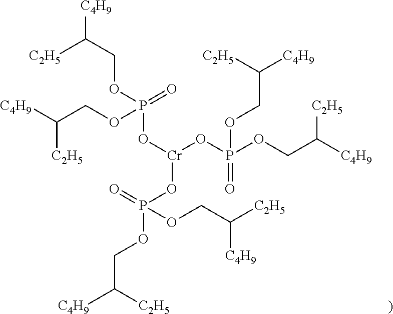

was replaced with Chromium compound (II) (having a structure of

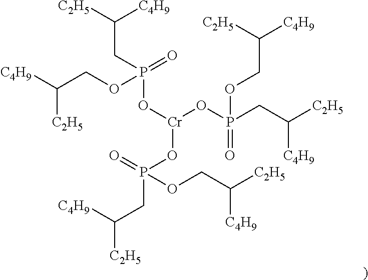

(hereinafter referred to as Cr(P507)₃). The product was analyzed by gas chromatography. The results show a 97% selectivity for 1-hexene, less than 1% selectivity for polyethylene (PE), and a catalyst activity of 2.1×10⁵ g/g-Cr h⁻¹.

### Comparative Example 1

Comparative Example 1 was performed in the same manner as in Example 1, except that Chromium compound (I) (having a structure of

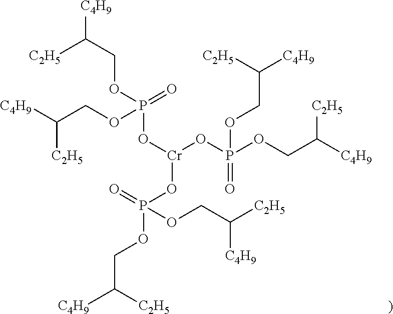

was replaced with Chromium (III) 2-ethylhexanoate (hereinafter referred to as Cr (2-EH) 3). The product was analyzed by gas chromatography. The results show a 94% selectivity for 1-hexene, less than 1% selectivity for polyethylene (PE), and a catalyst activity of 1.8×10⁵ g/g-Cr h⁻¹.

Table 1 lists the reagents and content used in Example 1, Example 2, and Comparative Example 1.

TABLE 1

| | Example 1 | | | Example 2 | | | Comparative Example 1 | | |
|---|---|---|---|---|---|---|---|---|---|
| | reagent | content | | reagent | content | | reagent | content | |
| chromium | Cr(P204)₃ | 6.3 | μmol | Cr(P507)₃ | 6.3 | μmol | Cr(2-EH)₃ | 6.3 | μmol |
| compound | | | | | | | | | |
| ligating | DMP | 18.9 | μmol | DMP | 18.9 | μmol | DMP | 18.9 | μmol |
| compound | | | | | | | | | |
| cocatalyst | TEA | 189.0 | μmol | TEA | 189.0 | μmol | TEA | 189.0 | μmol |
| reaction | TCE | 31.5 | μmol | TCE | 31.5 | μmol | TCE | 31.5 | μmol |
| accelerator | | | | | | | | | |
| solvent (ml) | CH | 100 | mL | CH | 100 | mL | CH | 100 | mL |

| | | | |
|---|---|---|---|
| ethylene (psi) | 550 psi | 550 psi | 550 psi |
| reaction | 80° C. | 80° C. | 80° C. |
| temperature | | | |

Table 2 shows the oligomerization reaction analysis results described in Example 1. Example 2, and Comparative Example 1.

TABLE 2

| | Example 1 | Example 2 | Comparative Example 1 |
|---|---|---|---|
| catalyst activity | 7.8 × 10⁵ | 2.1 × 10⁵ | 1.8 × 10⁵ |
| | g/g-Cr h⁻¹ | g/g-Cr h⁻¹ | g/g-Cr h⁻¹ |
| selectivity | 97% | 97% | 94% |
| (1-hexene) | | | |

### Example 3

A high-pressure reaction kettle (300 mL) was heated at 120° C. under vacuum for at least 4 hours to remove moisture and oxygen from the reactor. Next, under nitrogen atmosphere, cyclohexane (CH) (5 mL), bis(diphenylphosphino) isopropylamine (Ph₂PNPPh₂-iPr) (13.5 μmol), Chromium compound (I) (having a structure of

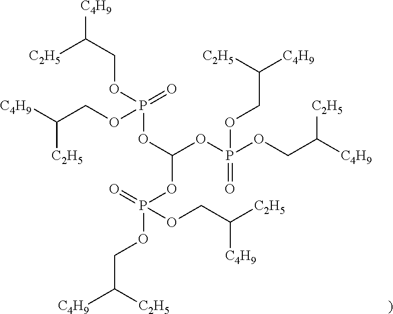

(10 μmol) (Cr(P204)₃) were sequentially added into a reaction bottle. After stirring for 30 minutes, a solution (A) was obtained.

Next, under nitrogen atmosphere, cyclohexane (5 mL) and methylaluminoxane (MAO) (commercially available from Tosoh Corporation with a trade name of TMAO) (dissolved in toluene) (2000 μmol) were added into a reaction bottle. After stirring for 30 minutes, a solution (B) was obtained.

After injecting solution (A) into a feed tube, the feed tube was installed into the high-pressure reaction kettle and an ethylene feed tube was also installed into the high-pressure reaction kettle. Next, air was removed from the connection points. After cooling the high-pressure reaction kettle to room temperature, cyclohexane (90 mL) was added into the high-pressure reaction kettle and stirred at a rotation speed of over 500 rpm. After replacing the nitrogen in the reactor with ethylene, the solution (B) was injected into the high-pressure reaction kettle and then the high-pressure reaction kettle was heated to 80° C. Next, the solution (A) was injected from the feed tube into the high-pressure reaction kettle using ethylene at 650 psi. After 30 minutes of reaction, the high-pressure reaction kettle was cooled to 20° C. using an ice bath and then the pressure was released. The product was analyzed by gas chromatography. The results show a 60% selectivity for 1-octene, 10% selectivity for polyethylene (PE), and a catalyst activity of 2.4×10⁵ g/g-Cr h⁻¹.

### Example 4

Example 4 was performed in the same manner as in is Example 3, except that Chromium compound (I) (having a structure of

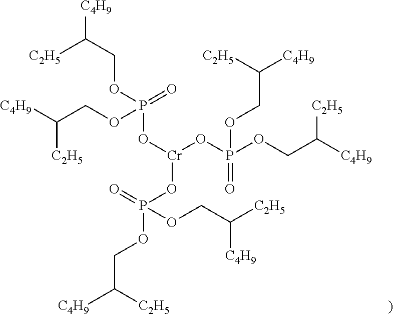

was replaced with Chromium compound (II) (having a structure of

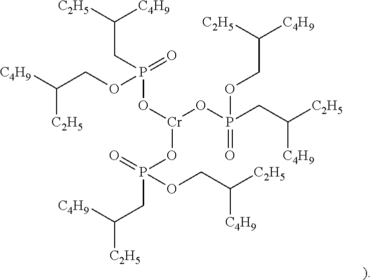

The product was analyzed by gas chromatography. The results show a 62% selectivity for 1-octene, 8% selectivity for polyethylene (PE), and a catalyst activity of 3.2×10⁵ g/g-Cr h⁻¹.

### Comparative Example 2

Comparative Example 2 was performed in the same manner as in Example 3, except that Chromium compound (I) (having a structure of

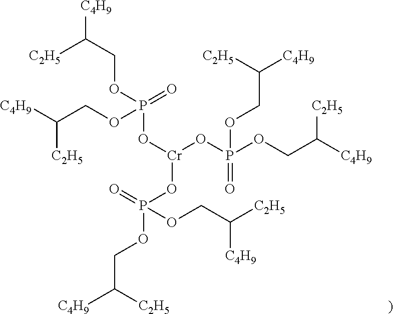

was replaced with acetone chromium (hereinafter referred to as Cr(acac)₃). The product was analyzed by gas chromatography. The results show a 68% selectivity for 1-octene, 14% selectivity for polyethylene (PE), and a catalyst activity of 1.1×10⁵ g/g-Cr h⁻¹.

Table 3 lists the reagents and content used in Example 3, Example 4, and Comparative Example 2.

TABLE 3

| | Example 3 | | | Example 4 | | | Comparative Example 2 | | |
|---|---|---|---|---|---|---|---|---|---|
| | reagent | content | | reagent | content | | reagent | content | |
| chromium | Cr(P204)₃ | 10 | μmol | Cr(P507)₃ | 10 | μmol | Cr(acac)3 | 10 | μmol |
| compound | | | | | | | | | |
| ligating | Ph₂PNPPh₂—iPr | 13.5 | μmol | Ph₂PNPPh₂—iPr | 13.5 | μmol | Ph₂PNPPh₂—iPr | 13.5 | μmol |
| compound | | | | | | | | | |
| cocatalyst | MAO | 2000 | μmol | MAO | 2000 | μmol | MAO | 2000 | μmol |
| solvent (ml) | CH | 100 | mL | CH | 100 | mL | CH | 100 | mL |

| | | | |
|---|---|---|---|
| ethylene (psi) | 650 psi | 650 psi | 650 psi |
| reaction | 80° C. | 80° C. | 80° C. |
| temperature | | | |

Table 4 shows the oligomerization reaction analysis results described in Example 3, Example 4, and Comparative Example 2.

TABLE 4

| | Example 3 | Example 4 | Comparative Example 2 |
|---|---|---|---|
| catalyst activity | 2.4 × 10⁵ | 3.2 × 10⁵ | 1.1 × 10⁵ |
| | g/g-Cr h⁻¹ | g/g-Cr h⁻¹ | g/g-Cr h⁻¹ |
| selectivity | 60% | 62% | 68% |
| (1-octene) | | | |

Accordingly, the catalyst composition for olefin oligomerization of the disclosure includes a specific chromium compound (such as a chromium-containing phosphate compound). The chromium compound of the disclosure may serve as a catalyst precursor in the ethylene trimerization/tetramerization reaction for use in concert with a ligating compound, a cocatalyst, and/or an additive, thereby forming a catalytically active system with higher catalyst activity and improved product selectivity.

It will be clear that various modifications and variations can be made to the disclosed methods and materials. It is intended that the specification and examples be considered as exemplary only, with the true scope of the disclosure being indicated by the following claims and their equivalents.

What is claimed is:

1. A catalyst composition for olefin oligomerization, comprising:
a chromium compound, wherein the chromium compound has at least one substituted or non-substituted phosphate ligand;
a ligating compound; and
a cocatalyst.

2. The catalyst composition for olefin oligomerization as claimed in claim 1, wherein the chromium compound has a structure represented by Formula (I) 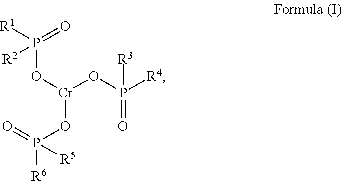
wherein R¹, R², R³, R⁴, R⁵ and R⁶ are independently hydrogen, C1-C25 alkyl group, or C1-C25 alkoxy group, and at least one of R¹, R², R³, R⁴, R⁵ and R⁶ is C1-C25 alkyl group, or C1-C25 alkoxy group.

3. The catalyst composition for olefin oligomerization as claimed in claim 2, wherein at least one of R¹, R², R³, R⁴, R⁵ and R⁶ is a group having a structure represented by Formula (II) or Formula (III) 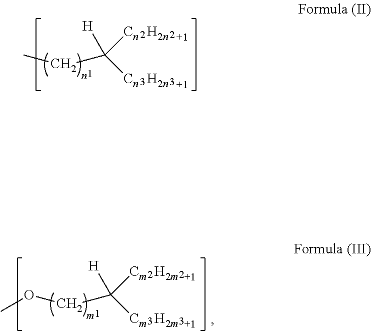
wherein n¹, n², and n³ are independently 0 or an integer of 1-8; and m¹, m², and m³ are independently 0 or an integer of 1-8.

4. The catalyst composition for olefin oligomerization as claimed in claim 2, wherein R¹, R³, and R⁵ are the same, and R², R⁴, and R⁶ are the same.

5. The catalyst composition for olefin oligomerization as claimed in claim 1, wherein the ligating compound has a structure represented by Formula (IV) or Formula (V) 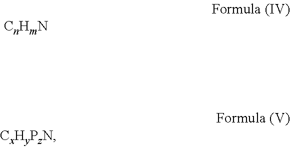
wherein n is an integer of 5-20, m is an integer of 7-37, x is an integer of 7-38, y is an integer of 19-49, and z is an integer from 2-4.

6. The catalyst composition for olefin oligomerization as claimed in claim 1, wherein the ligating compound is a pyrrole compound having a structure represented by Formula (VI) 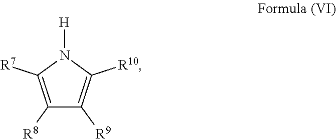
wherein R⁷, R⁸, R⁹ and R¹⁰ are independently hydrogen, or C1-C4 alkyl group, and at least one of R⁷, R⁸, R′ and R¹⁰ is C1-C4 alkyl group.

7. The catalyst composition for olefin oligomerization as claimed in claim 1, wherein the ligating compound has a structure represented by Formula (VII) 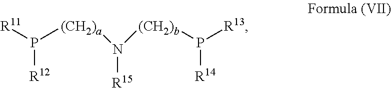
wherein R¹¹, R¹², R¹³ and R¹⁴ are independently C1-C6 alkyl group, C4-8 cycloalkyl group, C6-C12 aryl group, or C7-C22 alkylaryl; R¹⁵ is C1-C6 alkyl group, or C4-8 cycloalkyl group; a is 0, or an integer of 1-6; and b is 0, or an integer of 1-6.

8. The catalyst composition for olefin oligomerization as claimed in claim 1, wherein the cocatalyst is aluminoxane, alkylaluminum, or a combination thereof.

9. The catalyst composition for olefin oligomerization as claimed in claim 1, wherein the cocatalyst has a structure represented by Formula (VIII) 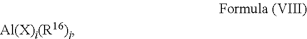
wherein X is fluorine, chlorine, bromine, or iodine.; R¹⁶ is C1-C6 alkyl group; i is 0, 1, or 2; j is 1, 2, or 3; and i+j is 3.

10. The catalyst composition for olefin oligomerization as claimed in claim 1, further comprising:
a reaction accelerator.

11. The catalyst composition for olefin oligomerization as claimed in claim 10, wherein the reaction accelerator is fluorine-substituted C2-C4 alkane, chlorine-substituted C2-C4 alkane, bromine-substituted C2-C4 alkane, or a combination thereof.
